(19) United States
(12) Patent Application Publication
(10) Pub. No.: US 2003/0045298 A1
(43) Pub. Date: Mar. 6, 2003

(54) Method and apparatus for predicting the behavior of applications by simulating data flow through a data communications network

(76) Inventors: Samuel W. Linton, Sunnyvale, CA (US); John W. Wallerius, Sunnyvale, CA (US)

Correspondence Address: James H. Salter, BLAKELY, SOKOLOFF, TAYLOR & ZAFMAN LLP, Seventh Floor, 12400 Wilshire Boulevard, Los Angeles, CA, 90025-1026, US

(21) Appl. No.: 09/823,789

(22) Filed: Mar. 30, 2001

(51) Int. Cl. H04Q 7/20

(52) U.S. Cl. 455/452

(57) ABSTRACT

The present invention is a method and a means of predicting the usability of specific applications or general types of applications in a data communications or wireless network within either specific geographic areas or general types of geography, such as a typical suburban environment. The invention provides a means of using information about the statistics of relevant Quality of Service parameters such as data throughput and delay as a function of location and velocity, to simulate the behavior of applications as a function of location and velocity in the data communications or wireless environments.

### FIELD OF THE INVENTION

The present invention relates to the field of data communications and/or wireless networks. In particular, the present invention relates to the testing of applications and the simulation of data flow through a network.

### BACKGROUND OF THE INVENTION

Wireless data applications such as streaming audio and video, web surfing, email and other non-voice applications are beginning to emerge, supplementing the voice services that have been available for the last several decades. Throughout the world, wireless networks, which will support the transfer of data between mobile and stationary devices at rates ranging from tens of kilobits to tens of megabits of data per second, are being planned and implemented. Much of the connectivity and functionality that people have come to associate with the Internet will be available on wireless devices. In Japan, for example, the Internet is accessed more often from wireless devices than from stationary devices.

However, unlike a traditional data connection over wire or fiber optic transmission media, the bandwidth of a wireless connection is highly variable, particularly when one or both ends of a link are in motion. The bandwidth of any given wireless link depends in part on the exact locations of the sender and receiver, the physical environment between and around the sender and receiver, the velocities of sender and receiver, any other transmitters using the same or adjacent frequencies, the number of antennas used for sending and receiving, and many other variables. problems afflict wireless voice transmissions, as well as all other forms of wireless communications. The data rate of any particular voice telephone call is relatively low, and does not vary a great deal for any given connection. Some other data applications such as web surfing demand both much higher peak data rates, and have much greater variability in offered load, i.e. the amount of data that the user requests to be transferred at any particular time. The combination of high required data rates, high variability in offered load, and high variability in actual available bandwidth of wireless connections combine to create a very serious problem for network operators, network infrastructure companies, and content providers. All of these groups are counting on selling wireless data services across broad and diverse geographic areas. What applications will work well enough in a wireless environment to generate revenue? Where will they work well enough? How much infrastructure is required to achieve the level of Quality of Service (QoS) that users will demand in a wireless world? These questions and the underlying problems related to wireless networks are unresolved by conventional technology.

### SUMMARY OF THE INVENTION

The present invention is a method and a means of predicting the usability of specific applications or general types of applications in a data communications or wireless network within either specific geographic areas or general types of geography, such as a typical suburban environment. The invention provides a means of using information about the statistics of relevant Quality of Service parameters such as data throughput and delay as a function of location and velocity, to simulate the behavior of applications as a function of location and velocity in the data communications or wireless environments.

### BRIEF DESCRIPTION OF THE DRAWINGS

FIG. 1 illustrates an example of a means of producing QoS statistics by user location and speed.

FIG. 2 illustrates an embodiment of the Wireless Application Simulation Machine of the present invention.

FIG. 3 illustrates the present invention in the context of a network system.

### DETAILED DESCRIPTION

The present invention is a method and a means of predicting the usability of specific applications or general types of applications in a data communications or wireless network within either specific geographic areas (e.g. Manhattan, Downtown Los Angeles) or general types of geography, such as a typical suburban environment. The invention provides a means of using information about the statistics of relevant QoS parameters such as data throughput and delay as a function of location and velocity, to simulate the behavior of applications as a function of location and velocity in the data communications or wireless environments. In the following detailed description, numerous details are set forth in order to provide a thorough understanding of the present invention. However, it will be apparent to one of ordinary skill in the art that these specific details need not be used to practice the present invention. In other circumstances, well- known structures, materials, circuits, processes, and interfaces have not been shown or described in detail in order not to unnecessarily obscure the present invention.

In one embodiment of the invention, the invention produces a mapping:

F(userLocation, userSpeed)→ distributionOfQoSVariable

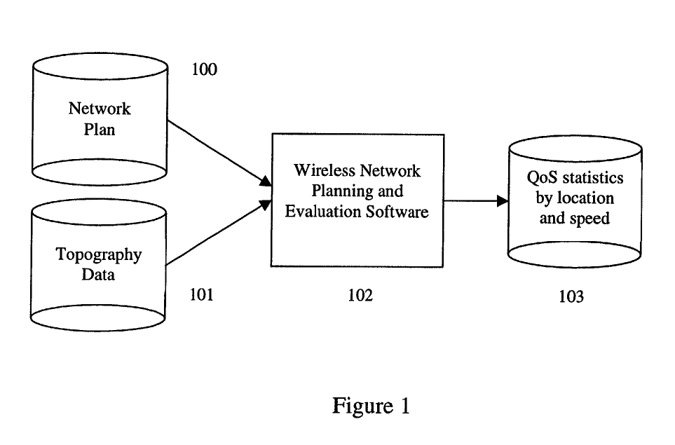

for each of a sample set of points within the space user locations and user speeds of interest. FIG. 1 illustrates a means of producing such a mapping using a computer program embodying a conventional wireless network planning and evaluation tool. An alternative means of producing such QoS information involves driving throughout an area of interest, sending and receiving radio signals to measure the characteristics of the radio environment such as average attenuation of signal strength, multipath spreading of signals as they bounce off obstructions, etc. Often this empirical data, such as drive testing and computer modeling are combined, with the results of empirical data extrapolated and interpolated to unmeasured areas and to proposed but as yet non-existent base stations, antennas, etc. by mathematical techniques executed by the planning tool.

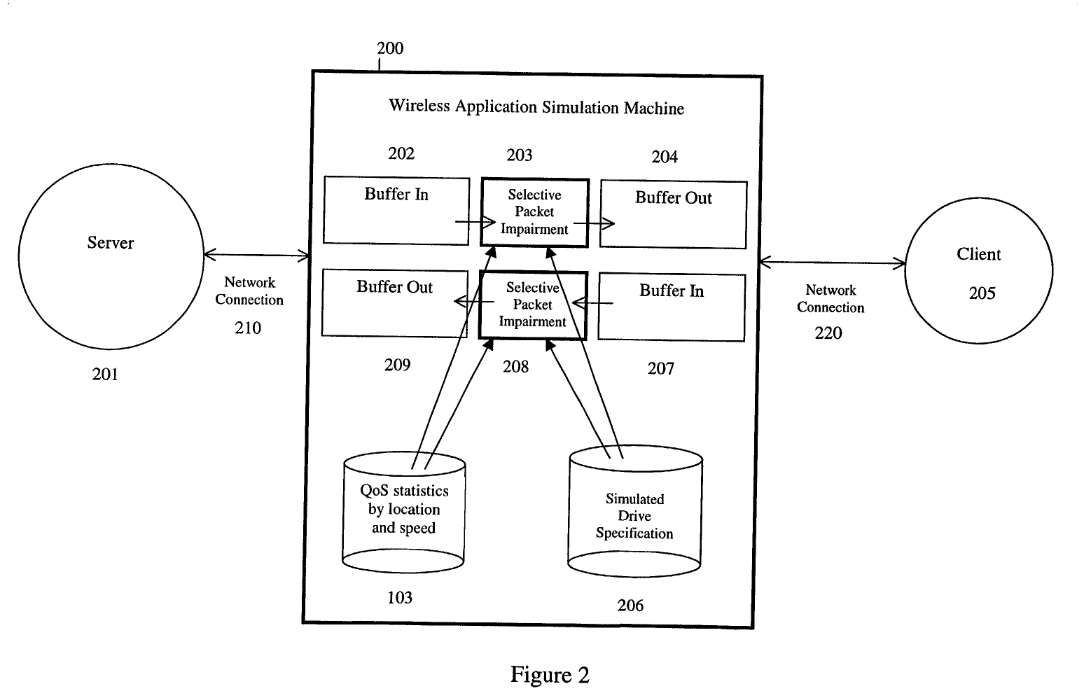

QoS statistics generated in a manner described above are then used by the present invention to operate on a data flow generated by any application to be evaluated. In this manner, the present invention can evaluate an application-under-test in the simulated conditions of an actual data communications or wireless network. As such, the present invention provides a simulator for simulating the operation of an application-under-test in a specific network environment. FIG. 2 illustrates an embodiment of a method and apparatus 200 for using QoS statistics specific to location and speed 103 to modify application data flows in a manner that accurately approximates the data transmission impairments that would be encountered by a user traversing the locations at the velocities that are specified in a Simulated Drive Specification 206. The simulated drive specification could be specific to, for example, roads and speeds, or it could be statistical in nature, allowing for some degree of randomness in the traversal of the space of interest. The simulated drive specification could be stored on a storage medium, or in another embodiment, it could be specified in real time by a human operator controlling the simulation as it runs.

In one embodiment, a human subject operates the client application (i.e. the application-under-test). The acceptability of any particular wireless application is both a function of the statistics of the data flow through it and of human perceptual psychology. Human perceptual psychology is not well understood. For this reason, it is common practice across many industries to evaluate the appeal and usability of products by testing the products on individual users or groups of users. In the case of wireless applications, the variance in human reactions to a particular application is compounded by the variability in the data rate of the wireless environment. Using the method and apparatus of this invention, a human response to the combination of application and environmentally imposed quality of service variability can be studied.

In another embodiment, instead of a human operator, a software model of a human operator interacts with the client application. Such a model could, for example, be derived by recording the behavior of actual humans who had previously used the simulation. Using automated learning techniques such as neural nets, patterns of interaction can be learned and replicated, and learned patterns of usability rating can be applied to automatically applied to evaluate the usability of applications under test.

FIG. 1 illustrates an example of a means of producing QoS statistics by user location and speed. A conventional wireless network planning and evaluation program 102 reads in network plan data 100 and topography data 101. Program 102 processes this information to produce QoS statistics by location and speed 103. The QoS statistics by location and speed 103 may alternatively be produced by performing physical measurements on the radio environment in the area of interest and storing the results in some data storage medium.

FIG. 2 illustrates an embodiment of the Wireless Application Simulation Machine 200 of the present invention. The Wireless Application Simulation Machine 200 is connected by standard network connections 210 and 220 such as IP (Internet Protocol) or ATM (Asynchronous Transfer Mode) to a client device 205 and a server device 201. In an alternative embodiment, the client or the server device, or both devices are emulated in software inside of the Wireless Application Simulation Machine 200. In alternative embodiments, devices with a peer-to-peer (i.e. symmetrical) relationship can be connected through the Wireless Application Simulation Machine 200 or emulated in software inside the Wireless Application Simulation Machine. Information passes between the devices 201 and 205 through the Wireless Application Simulation Machine 200. Data flowing from device 201 is buffered in memory buffer 202.

This buffer is read by the Selective Packet Impairment unit 203, which can be implemented in an embodiment as a software program executing on a processor contained in Wireless Application Simulation Machine 200. The Selective Packet Impairment unit 203 also takes as input QoS statistics 103 and Simulated Drive Specification 206. The QoS statistics data 103 is produced in the manner described above. The simulated drive specification 206 specifies a sequence of movements through the data communications or wireless network space covered by the QoS statistics 103. The Selective Packet Impairment Unit reads drive path information from the Simulated Drive Specification 206 and uses the location and speed information stored there to access the QoS statistics associated with this information stored in the QoS statistics store 103. The packets read into the Selective Packet Impairment unit 203 are intentionally and selectively impaired according to the statistical description supplied by the QoS statistics store 103. The impairment may consist of corrupting bits in the packet, or by not passing the packet through at all to the output buffer 204. Some packets are passed directly through to the output buffer 204. In one embodiment, the impairments of the packets are governed by pseudo-random number generators. The statistics of the pseudo-random impairments are determined by the input from the QoS statistics store 103. In any case, the data flowing to the application-under-test is impaired to a degree corresponding to the QoS data. The output buffer 204 is transmitted to the client device 205.

In one embodiment, wireless network delays such as those caused by the coding and interleaving of wireless data to overcome impairments caused by radio environments is emulated by delaying the transfer of packets from the input buffer 202 to the output buffer 204. Such delays are typically more than 40 milliseconds in modern digital wireless communications systems, which allows the Selective Packet Impairment unit to have time to perform the required processing while maintaining an accurate simulation of true wireless network delays, without having to add spurious delays which might otherwise come as artifacts of the required processing time.

In one embodiment, data flowing from the client 205 to the server 201 flows through the Wireless Application Simulation Machine from client 205 into input buffer 207, where it is processed by the Selective Packet impairment unit 208. In one embodiment, the Selective Packet Impairment units 203 and 208 are implemented as a single software program running an a processor in the Wireless Application Simulation Machine 200. The Selective Packet Impairment unit 208 functions to intentionally and selectively impair packets in the same way that unit 203 does, although the statistics it receives from QoS statistics store 103 may be different, if the two simulated paths of the bi-directional link between devices 205 and 201 have different characteristics. As in the Server 201 to Client 205 flow, packets are selectively impaired by selective packet impairment unit 208 and the surviving ones (impaired or not) are passed through to an output buffer 209, for transmission to the server 201. In an alternative embodiment, data only flows in one direction through the Wireless Application Simulation Machine 200, so only one of the two data paths through the machine exists.

In one embodiment, a human user interacts with the client device 205 for the purpose of evaluating the usability of the application being run in the context of the network plan 100 and topography 101. In an alternative embodiment, automatic means are used to measure the flow of packets to estimate the usability of the application being run.

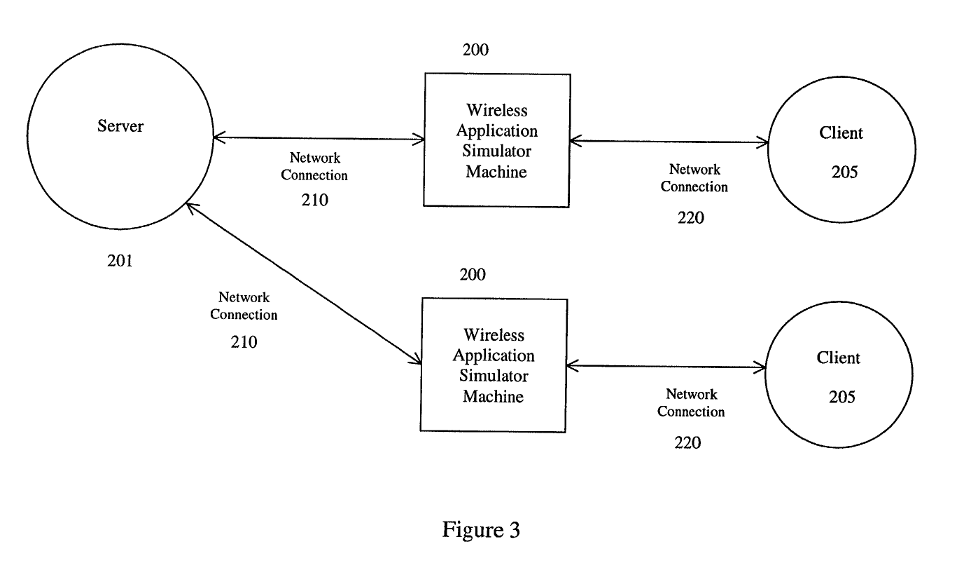

FIG. 3 illustrates the present invention in the context of a network system. Server 201 can service a plurality of simulator machines 200, which may service a plurality of clients 205. Alternatively, each simulator 200 can service a plurality of clients 205 and multiplex data for a plurality of clients 205 onto a single network connection 210 to server 201.

The basic processing performed by one embodiment of the application simulator 200 of the present invention is described below in the form of pseudo-code, which describes the basic processing flow. It will be apparent to those of ordinary skill in the art that alternative implementations of the basic processing flow described below are possible without departing from the scope of the claimed invention. The following pseudo-code assumes that the QoS store 103 has stored therein a table indexed by location in latitude and longitude, and velocity in meters/sec. Each entry in this table has the following information: probability of bit error in the underlying uncoded data stream throughput at this point in time, in bits/second latency at this point in time, in seconds. As described above, the creation of this table in store 103 can be implemented using well-known techniques.

Pseudo-code for the Application Simulator of One Embodiment of the Present Invention

PacketIn interrupt service routine

[on interrupt generated by receiving packet through network interface hardware]

currentSimTime = timeStepCounter * SECONDS_PER_TIMESTEP;
probPacketError =

computeProbabilityOfPacketError(length(currentPacket), currentSimTime);

delay = computeDelay(length(currentPacket), currentSimTime);
// uniformRandNumGen() is a function that generates a uniform distribution
// of pseudoRandom numbers. Such generators typically require a state variable,
// which in this case is represented by stream1
if ( uniformRandomNumberGen(stream1) <probPacketError) {

// corrupt packet. The corruptPacket function can in
// in an embodiment be a function that selects a random
// bit for toggling, which will cause the packet checksum
// to be wrong, thus alerting a recipient that retransmission
// is needed.
corruptPacket(currentPacket);

}
// put packet on output queue, with an output timestamp appropriate to
// the delay of the system being simulated
// packet is inserted onto queue in order of output time, so
// the packet that is next to go out is always at the head of the queue
addPacketToOutputQueue( currentPacket, currentTime+delay);

[end of PacketIn interrupt service routine]
double computeProbabilityOfPacketError( int numBytesInPacket, currentSimTime)
{

// look up the simulated velocity from Simulated Drive Specification 206
currentVelocity = getVelocity(currentSimTime);
// look up simulated location from Simulated Drive Specification 206
currentLocationLatitude = getLocationLatitude(currentSimTime);
currentLocationLongitude = getLocationLongitude(currentSimTime);
// look up the probability of bit error for this location
// in QoS store 103
numBitsInPacket = numBytesInPacket * 8;
// in this example, the QoS store has a three dimensional table indexed by
// location (in units of latitude and longitude), and velocity
// lookup function interpolates where necessary
probBitError = lookUpBitErrorStats(currentLatitude, currentLongitude, currentVelocity);
// translate bit error rate into probability that packet has at least one bit error
// which will cause a failure in the cyclic redundancy check for the packet at
// the destination.
probPacketError = 1 − (1 − probBitError)^{numBitsInPacket};
return probPacketError;

}
double computeDelay( int numBytesInPacket, currentSimTime)
{

// look up the simulated velocity from Simulated Drive Specification 206
currentVelocity = getVelocity(currentSimTime);
// look up simulated location from Simulated Drive Specification 206
currentLocationLatitude = getLocationLatitude(currentSimTime);
currentLocationLongitude = getLocationLongitude(currentSimTime);
// lookup the throughput in bits/sec QoS store 103
currentDataRate = lookUpRate(currentLatitude, currentLongitude, currentVelocity);
currentLatency = lookUpLatency(currentLatitude, currentLongitude, currentVelocity);
// add latency caused by coding, interleaving, etc. for current network being simulated,
// plus raw transmission delay caused by data rate of channel.
delay = currentLatency + (currentDataRate * numBytesInPacket * 8 /* bits per byte*/);
return delay;

}
Clock interrupt service routine.
// In clock interrupt service routine, processed packets
// (i.e. packets that have been selectively delayed and/or impaired)
// are passed from the output buffer (204 or 209) to be immediately
// output onto network connections (220 or 210 respectively)
// Count clock interrupts until one timeStep is elapsed.
// Clock interrupts occur at rates determined by the hardware
// in use, but rates of under 1 millisecond are easy to achieve using
// ordinary personal computers.
//
// The timeStep should be chosen to be fast enough that the
// granularity of output is not perceptible by a human user.
// 10 milliseconds would be a reasonable value
//
//
[On clock interrupt]

intCtr++;
if (intCtr > interruptsPerTimeStep) {

intCtr = 0;
timeStepCounter++;
currentSimTime = timeStepCounter * SECONDS_PER_TIME_STEP;
while ( outTimeOfNextPacket() < timeStepCounter) {

// this function sends packets to output hardware
// and also advances output queue
// all packets destined for output in this timeStep are
// sent, so timeStep doesn't limit output rate
sendPacketToOutputHardware();

}

}

[End of clock interrupt service routine]

Thus, a method and apparatus for predicting the behavior of applications by simulating data flow through a data communications network is disclosed. Although the present invention is described herein with reference to a specific preferred embodiment, many modifications and variations therein will readily occur to those with ordinary skill in the art. Accordingly, all such variations and modifications are included within the intended scope of the present invention as defined by the following claims.

What is claimed is:

1. A method comprising:
obtaining quality of service (QoS) data related to information flow through a data communications network;
receiving input data from an application;
producing impaired data from the input data, the impaired data being impaired to a level corresponding to the QoS data; and
providing the impaired data to the application.

2. The method as claimed in claim 1 wherein the data communications network is a wireless network.

3. The method as claimed in claim 1 wherein the QoS data includes information indicative of a distribution of throughput.

4. The method as claimed in claim 1 wherein the QoS data includes information indicative of a time correlation of throughput.

5. The method as claimed in claim 1 wherein the QoS data includes information empirically determined.

6. The method as claimed in claim 1 wherein the QoS data includes information modeled from empirically determined data.

7. The method as claimed in claim 1 wherein the QoS data includes information indicative of a distribution of throughput.

8. The method as claimed in claim 1 wherein the impaired data includes intentionally corrupted data packets.

9. The method as claimed in claim 1 wherein the impaired data includes intentionally lost data packets.

10. The method as claimed in claim 1 wherein the impaired data includes randomly impaired data packets.

11. The method as claimed in claim 1 wherein providing the impaired data includes intentionally delaying data packets.

12. The method as claimed in claim 1 further including receiving information indicative of a sequence of movements through the data communications network, the information indicative of a sequence of movements through the data communications network being used to access corresponding QoS data.

13. The method as claimed in claim 1 further including receiving information indicative of user input to the application, the information indicative of user input to the application being used to produce the impaired data.
